(19) United States
(12) Patent Application Publication
(10) Pub. No.: US 2024/0289281 A1
(43) Pub. Date: Aug. 29, 2024

(54) System for Memory Resident Data Movement Offload and Associated Methods

(71) Applicant: IntelliProp, Inc., Longmont, CO (US)

(72) Inventors: Erich Hanke, Boulder, CO (US); Tracy Robert Spitler, Boulder, CO (US); James Milton Hull, Mountain View, CA (US)

(21) Appl. No.: 18/115,607

(22) Filed: Feb. 28, 2023

(51) Int. Cl. G06F 12/1045; G06F 12/0882; G06F 13/16

(52) U.S. Cl. CPC G06F 12/1063; G06F 12/0882; G06F 13/1642

(57) ABSTRACT

A memory access engine is configured to receive a request comprising a command and to determine whether the command comprises an atomic command. If the command comprises the atomic command, the memory access engine determines whether the command includes a virtual address or a physical address. Based on determining that the command includes a virtual address, the memory access engine translates the virtual address to a corresponding physical address. The memory access engine determines an opcode included in the command and, based on the opcode, adds the command and the physical address to a particular queue of a plurality of queues. While a central processing unit (CPU) performs processing tasks, the memory access engine, based on the command, operates a memory fabric and, after receiving a message from the memory fabric indicating that the memory command has been completed, updates a status associated with the command to a completed status.

### FIELD OF THE INVENTION

The present invention relates to data management within a computing architecture. More particularly, this invention pertains to devices, systems, and associated methods for achieving computational speed increases in a computing architecture by reducing memory-related data transfers performed by one or more central processing units (CPUs).

### BACKGROUND OF THE INVENTION

Modern data center architectures are expanding to support tiered memory systems that make up the memory range addressable from a processing unit (PU), such as a central processing unit (CPU), graphics processing unit (GPU), or digital signal processor (DSP). Common architectures task the PU to access memory tiers using standard load and store accesses that are typically aligned to the PU cache-line size. Each data load/store step into the memory hierarchy increases access latency. For example, a memory hierarchy may include PU registers (register file), on-chip cache hierarchy (e.g., level 1, level, 2, level 3) including private and shared caches, high bandwidth memory, local double data rate (DDR) memory, locally attached coherent non-DDR memory, and/or fabric attached memory (FAM) that may exist behind one or more switch layers.

Bulk data movement between PU addressable memory ranges typically utilizes load/store instructions from the PU or specialized large load/store instructions. A limitation of known computing architectures is that, during the process of performing a transfer of bulk data, one or more PU cores may be occupied with the transfer process (e.g., issuing load and store operations). The greater the latency to access the source and/or destination address range, the longer the PU may be occupied and the higher the PU utilization. Additionally, the PU cores may be limited in the number of pre-fetch operations that can be performed before memory access is slowed down due to throttling by the PU local pre-fetchers.

Such known limitations may be exacerbated as the memory hierarchy in a computer architecture employs multiple, increasingly distant tiers. The longer latency access of the fabric attached memory (FAM), coupled with scaling limitations of hardware cache coherency, limit the functional value of FAM in a shared memory system for multi-node collaboration. Additionally, the longer latency access limits intelligent page placement techniques for hot/cold data management due to the PU overhead associated with migrating pages to different memory tiers. Thus, in many computing environments, accessing multiple tiers of memory, including FAM, may be inefficient because data transfers occupy a significant portion of each PU's workload, thereby competing with the other (e.g., application-specific) tasks each PU must otherwise perform.

Accordingly, a need exists for a solution to at least one of the aforementioned challenges in increasing the computation speed of computing architectures that employ memory hierarchies. For instance, an established need exists for system designs that may reduce memory-related data transfers performed by one or more processing units (PUs), and particularly in computing architectures that employ FAM.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a memory access engine that may retrieve a request comprising a command and may determine whether the command comprises an atomic command. If the command comprises the atomic command, the memory access engine may determine whether the command includes a virtual address or a physical address. Based on a determination that the command includes a virtual address, the memory access engine may retrieve a physical address corresponding to the virtual address. The memory access engine may determine an opcode included in the command and, based on the opcode, may add the command and the physical address to a particular queue of a plurality of queues. The memory access engine, based on the command, may issue a memory command to a memory fabric and, after receiving a message from the memory fabric indicating that the memory command has been completed, may update a status associated with the command to a completed status.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a schematic diagram depicting an exemplary system for memory resident data movement offload comprising one or more servers configured in data communication with a fabric attached memory (FAM) according to an embodiment of the present invention;

FIG. 2 is a schematic diagram depicting an exemplary Z-type direct memory access (ZDMA) engine according to an embodiment of the present invention;

FIG. 3 is a linked list diagram depicting an exemplary command descriptor and memory region page (MRP) lists according to an embodiment of the present invention;

FIG. 4 is a data structure diagram depicting an exemplary data type command descriptor according to an embodiment of the present invention;

FIG. 5 is a data structure diagram depicting an exemplary MRP list definition according to an embodiment of the present invention;

FIG. 6 is a data structure diagram depicting an exemplary atomic command descriptor according to an embodiment of the present invention;

FIG. 7 is flowchart depicting a data movement request process according to an embodiment of the present invention;

FIG. 8 is a flowchart depicting atomic command descriptor handling according to an embodiment of the present invention; and

FIG. 9 is a flowchart depicting data type command descriptor handling according to an embodiment of the present invention.

Like reference numerals refer to like parts throughout the several views of the drawings.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

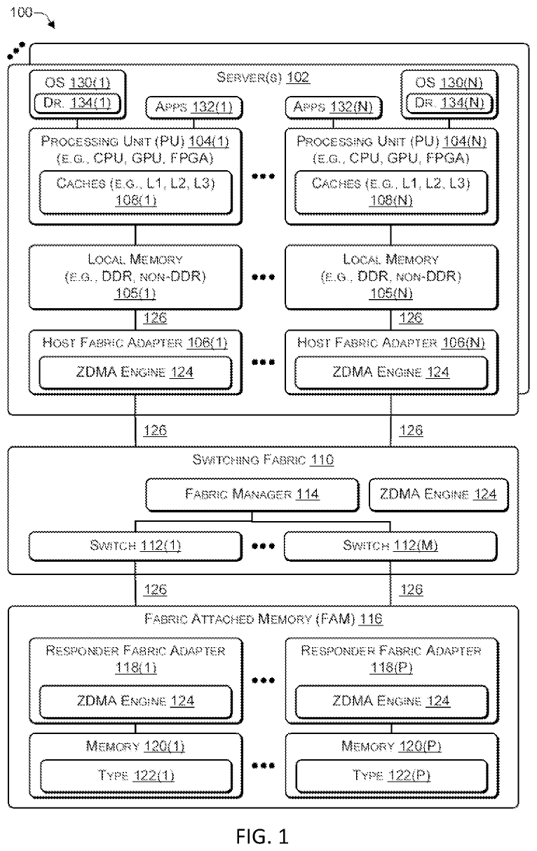

Referring initially to FIGS. 1-9, the systems, methods, and techniques hereinbelow describe a hardware data mover engine, known as a Z-type direct memory access (ZDMA) engine, that supports data movement between a host (e.g., processing unit (PU)) local memory (e.g., register file, cache), Fabric Attached Memory (FAM), and other types of memory accessible to the host, as well as the ability to support host initiated remote atomic operations that can be utilized for operational latency improvements and synchronization between multiple processing elements (e.g., PUs).

In various embodiments of the present invention, a ZDMA engine advantageously may offload data movement from PUs, such as a central processing (CPU), graphics processing unit (GPU), digital signal processor (DSP), and/or field programmable gate array (FPGA). The ZDMA engine may provide software controlled, hardware optimized, coherency communication between multiple processing elements. The ZDMA engine may be configured to issue remote atomic operations for latency improvement in long latency fabric environments. The ZDMA engine may perform address translations between a mixture of heterogeneous processing elements, each of which may have its own separate address mappings, and fabric attached memory. The ZDMA engine may provide processing element to processing element (e.g., PU to PU) messaging using a pre-allocated buffer mechanism. The ZDMA engine may employ a reduced latency local request queue supporting posted memory write requests from a host processing element. The ZDMA engine may provide for cache-line aligned memory requests, enabling data movement between fabric attached nodes with contiguous address ranges from 256 bytes (B) to 4 GigaBytes (GB).

The ZDMA engine may comprise byte addressable Control and Status Registers (CSR) and may be embedded into a fabric attached component (e.g., fabric adapter) that may be host coupled, endpoint coupled, or decoupled (e.g., configured as a standalone fabric attached entity). The ZDMA engine may include (1) control and status register (CSR) banks that are mappable within a single operating system (OS) kernel page to provide access control mechanisms and (2) a state machine that fetches commands and manages some number of host local memory resident submission queues and of device local latency optimized submission queues. Each device's local latency optimized submission queue may be uniquely mappable within a single OS kernel page to provide access control mechanisms. The ZDMA engine may further include (3) a message generation state machine, (4) a message consumption and translation state machine, (5) an atomic issue state machine, and (6) an atomic completion state machine. The ZDMA engine also may include (7) independent read data state machines and write data state machines, each with multiplexors and arbitration mechanisms employed to target host PU local memory (either with host physical addresses (HPA) or host virtual addresses (HVA)), or fabric memory address space. The ZDMA engine further may include (8) a completion state machine configured to receive response packets and to translate the response packets into appropriate completion structures. The ZDMA engine further may include (9) an address translation services (ATS) cache that may enable interacting with a host processing element Input-Output Memory Management Unit (IOMMU) for host virtual address to host physical address translation and for host physical address to host virtual address translation.

Completion structures, regardless of submission queue type, may be placed into paired completion queues. Completions may be cache line aligned (e.g., 64 bytes (B) in current processor architectures). Atomic responses may be included in the completion (no buffer is specified in an atomic operation (op) and no double read is performed). An interrupt may be generated (i) when interrupts are enabled, (ii) when a completion is posted if an interrupt on completion (IOC) bit is set when submitted (software can submit “X” data movement commands, a flush command, and an atomic (e.g., semaphore release) with the IOC set), and/or (iii) when configurable thresholds are met in the command queue (CQ).

In certain embodiments, the ZDMA is a non-processor (e.g., not a type of PU) hardware component to transfer data between a host local memory and FAM, between FAM and FAM, as well as from host to host, supporting address translation between host physical address (HPA) and fabric addresses (FA). The ZDMA engine may enable software to access the FAM via standard load/store instructions. In addition, the ZDMA engine may perform bulk data transfers, thereby freeing up PUs (e.g., CPU cycles) to perform other work. The ZDMA may offload the PUs by executing bulk memory data transfers using a block driver interface to the ZDMA hardware engine while maintaining cache coherency with the local host.

The ZDMA engine may provide per command address translation to enable host to host memory transfers using separate host physical address (HPA) descriptions of non-coherently connected CPU nodes, as well as per command translation of virtual address and host physical address. The ZDMA engine may enable independent submission and completion queues designed to match physical PU counts for lockless interaction between PUs and engine internal queue to enable low latency queue submission. The ZDMA engine may support data block sizes from 64 bytes (B) to 4 gigabytes (GB) per entry. The ZDMA engine may enable remote atomics with 8 bit (b) to 128b operands including: Add, Sum, Swap, CAS, Logical OR/XOR/AND, Test-Zero-and-Modify, Increment Bounded, Increment Equal, and Atomic Fetch. The ZDMA engine may place all completions, regardless of submission queue type, into a paired completion queue. All completions may be PU cache line aligned to 64B. All atomic responses may be included in the completion (no buffer specified in atomic op needed and no double read is used).

In certain embodiments, the ZDMA engine may be configured to perform various operations in parallel with a central processing unit (CPU). For example, the ZDMA engine may perform memory fabric operations, particularly large data transfers that can take a relatively long time to complete. In this way, the ZDMA engine offloads the CPU from performing memory fabric operations to enable the CPU to perform processing tasks that are unrelated to memory fabric. For example, while the CPU is performing processing tasks, the ZDMA engine may perform operations including retrieving, from a register interface, a request comprising a command and determining whether the command comprises an atomic command. For example, an operating system driver may place the request in the register interface. The command may include a source data pointer and a destination data pointer. The command may include a command descriptor and a plurality of memory region pages. Based on determining that the command comprises the atomic command, the operations include determining whether the command includes a virtual address or a physical address. Based on the determining that the command includes a virtual address, the operations include retrieving a physical address corresponding to the virtual address. For example, retrieving the physical address corresponding to the virtual address may include translating the virtual address to the physical address using an address translation services state machine included in the memory access engine. The operations include determining an opcode included in the command. For example, the opcode may be one of: command data, the atomic, or a message. The operations include adding the command and the physical address to a particular queue of a plurality of queues based on the opcode. For example, the plurality of queues may include: a message request queue, an atomic operation request queue, and a data transfer request queue. The operations include, based on the command, issuing a memory command to a memory fabric. The operations include, based on receiving a message from the memory fabric indicating that the memory command has been completed, updating a status associated with the command to a completed status

Referring initially to FIG. 1, an exemplary system 100 that includes one or more servers configured for memory resident data movement offload, according to an embodiment of the present invention, will now be described in detail. For example, and without limitation, one or more servers 102 may be configured in data communication with a fabric attached memory (FAM) 116 via a switching fabric 110. Each of the servers 102 may include multiple processing units (PU) 104(1) to 104(N), where N is greater than 0. Each PU 104 may include, for example, a central processing unit (CPU), a graphics processing unit (GPU), a digital signal processer (DSP), or a field programmable gate array (FPGA). Each processing unit 104 may include multiple levels of cache memory 108, such as a level 1 cache, a level 2 cache, level 3 cache, another type of cache, or any combination thereof. Each of the caches 108 is typically a memory that is located on the same chip as the PU 104 and, due to the proximity to the PU104, may be accessed with relatively low latency.

Each server 102 may include local memory 105 such as, for example, and without limitation, double data rate (DDR) memory or non-DDR memory. The local memory 105 may be located on the same motherboard as the PU 104 and may be accessible via a high-speed bus, such as a personal computing interface express (PCIe) bus or similar.

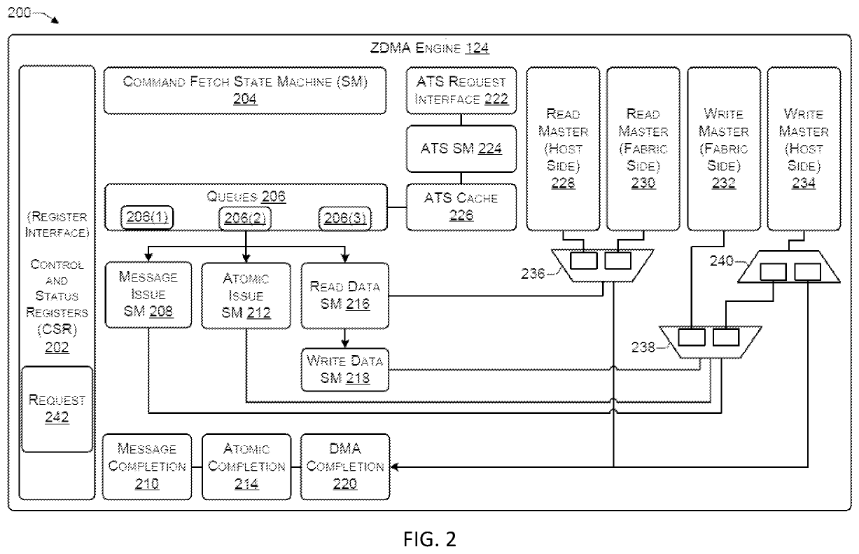

Each server 102 may include a host fabric adapter 106 that may be connected to the switching fabric 110 via a high-speed link 126, such as Compute Express Link™ (CXL) or similar. Each host fabric adapter 106 may include a hardware component referred to herein as ZDMA engine 124 configured to enable offloading of memory-related (e.g., FAM-related) operations from the processing units 104 to the ZDMA engine 124. An exemplary architecture of the ZDMA engine 124 is described hereinbelow in more detail for FIG. 2.

The switching fabric 110 may include multiple switches 112(1) to 112(M), where M is greater than 0. Such switches 112 may be used to route data to/from the FAM 116. In certain embodiments, the switching fabric 110 may include a fabric manager 114.

The fabric attached memory (FAM) 116 may include multiple responder fabric adapters 118(1) to 118(P), where P is greater than 0. Each responder fabric adapter 118 may include a respective instance of a ZDMA engine 124. Each of the responder fabric adapters 118 may access a particular memory component 120. Each memory component 120 may have a particular memory type 122. For example, and without limitation, the memory type 122 may include dynamic random-access memory (DRAM), phase change memory (PCM), resistive random-access memory (Re-RAM), or 3-D stack memory.

Each ZDMA engine 124 may comprise a hardware component that may be operable to transfer data between the local memory 105 and the FAM 116, between the FAM memories 120 (e.g., between memory 120(1) and memory 120(P)), as well as from host to host (e.g., from PU 104(1) to PU 104(N)), supporting address translation between host physical address (HPA) and fabric addresses (FA). The ZDMA engine 124 may enable software to access the FAM 116 using standard load/store instructions. In addition, the ZDMA engine 124 may perform bulk data transfers, thereby freeing up the PUs 104 to perform other work. The ZDMA engine 124 may offload data movement from the PUs 104 by executing bulk memory data transfers using a block driver interface while maintaining cache coherency of the caches 108 associated with the local host (e.g., the PUs 104).

The system 100 illustrates a small-scale system with links 126 (e.g., between PU's 104 and fabric adaptors 106 and as illustrated in FIG. 1) that, for example, and without limitation, may use a Compute Express Link™ (CXL) link to connect to the memory fabric adapters 106. Each fabric adapter 106 (and 118) may include one or more ZDMA modules 124. Each PU 104 may execute an operating system (OS) 130 and one or more applications (“apps”) 132. Each OS 130 may include a ZDMA driver 134 to communicate with one or more of the ZDMA engines 134. Each OS 130 may include a kernel that comprises the core of the OS 130. The kernel is the portion of the OS 130 that may reside in memory and may facilitate interactions between hardware and software. The kernel may control hardware resources via device drivers, including controlling the ZDMA engines 124 using the ZDMA driver 134.

The OS 130 running on each of the PU's 104 may use the drivers 134 to control the ZDMA engines 124. If the OS 130 (e.g., kernel of the OS 130) makes requests that can be accelerated by the ZDMA engine 124, then the software driver 134 may communicate with the ZDMA engine 124 through a register interface (illustrated in FIG. 2) to initiate the appropriate transaction. For each transaction, the software driver may be notified via an interrupt mechanism. Alternatively, the software driver may poll the register interface to determine a completion status of particular transactions.

In certain embodiments, the ZDMA engine 124 may be configured to advantageously provide software-controlled, hardware-optimized, coherency communication between multiple PUs 104 while offloading the movement of data from the PUs 104. The ZDMA engine 124 may issue atomic operations to reduce (e.g., improve) latency, particularly in long latency fabric environments. The ZDMA engine 124 may provide address translation between a mixture of heterogeneous PUs 104, each of which may use separate address mappings, and fabric attached memory 116. The ZDMA engine 124 may provide PU to PU messaging within a pre-allocated buffer mechanism, as described hereinbelow. A local request queue may support posted memory write requests from a host PU to provide low latency. The ZDMA engine 124 cache-line may align memory requests, thereby enabling data movement between fabric attached nodes, typically with (but not limited to) contiguous address ranges from 256 B to 4 GB. The ZDMA engine 124 may further comprise a hardware engine with byte addressable control and status registers (CSR) that may be embedded within a fabric attached component either host coupled (e.g., the host fabric adapter 106), endpoint coupled (the responder fabric adapter 118), or as a standalone fabric attached entity (e.g., within the switching fabric 110).

In summary, in a system that includes fabric attached memory, one or more of a host fabric adapter, a responder fabric adapter, and other components performing memory-related operations may include a ZDMA engine that may offload data movement functions from processing units to advantageously enable those processing units to perform other non-data movement related work. The ZDMA engine may maintain cache coherency and may enable hosts access to a heterogeneous memory environment with multiple types of memory, including DRAM, PCM, Re-RAM, and 3-D stack memory. The advantages of such a system include offloading virtual-to-physical address look up to a hardware offload engine and queuing of requests and completions enables the ZDMA engine to perform work without being gated by handshake between CPUs and the ZDMA engine. The ZDMA engine offloads the CPU from performing large data transfers in systems that use fabric accessible memory. In a conventional system that includes fabric accessible memory, the latency when transferring data might cause a lock on the CPU, preventing parallel processing and adversely affecting CPU performance. In contrast, in the systems described herein, the ZDMA engine offloads the CPU by issuing atomic commands to fabric devices and monitoring for the results of the execution of the atomic commands, thereby freeing the CPU to continue performing processing operations. In this way, the CPU and the ZDMA engine work in parallel to execute atomic commands on the fabric components, thereby improving system performance.

FIG. 2 is a block diagram 200 illustrating an architecture of a Z-type direct memory access (ZDMA) engine (e.g., the ZDMA engine 124 of FIG. 1), according to certain embodiments of the present invention. The ZDMA engine 124 may include control and status registers (CSR) 202, a command fetched state machine (SM) 204, and multiple subcommand queues 206. The queues 206 may be configured in signal communication with each of an assigned state machine (SM) (e.g., a message issue SM 208, an atomic issue SM 212, a read-data SM 216, and a write-data state machine queue 218). The ZDMA engine 124 may include an address translation services (ATS) request interface 222, an ATS state machine 224, and an ATS cache 226.

The ZDMA engine 124 may include a read master (host side) 228, a read master (fabric side) 230, a write master (fabric side) 232, and a write master (host side) 234. The read master (host side) 228 and the read master (fabric side) 230 may be configured in data communication with the read data state machine 216 via a multiplexer 236. The write master (fabric side) 232 may be configured in data communication with the write data state machine 218 via a multiplexer 238. The write master (host side) 234 may be configured in data communication, via a multiplexer 242, with the completion state machine 220. The multiplexer 240 may be configured in data communication with the multiplexer 238, as shown in FIG. 2. The read 223, 230 and write 232, 234 masters may be configured, through some combination of the multiplexers 236, 238, 240, with a message completion block 210, an atomic completion block 214, and a direct memory access (DMA) completion block 220.

The ZDMA engine 124 may include Control and Status Registers (CSR) 202 (also referred to as the Register Interface because these registers may be used to interface with the ZDMA engine 124) that may be mappable within a single Operating System (OS) Kernel page to provide access control mechanisms. The Command Fetching State Machine 204 may manage multiple queues 206, including host local memory resident submission queues, and device local, latency optimized (e.g., reduced latency), submission queues. Each device's local, latency optimized, submission queue may be uniquely mapped within a single OS Kernel page to provide access control mechanisms. Independent Read Data SM 216 and Write Data SM 218 may work with multiplexors 236, 238, 240 and arbitration mechanisms used to target host PU local memory 105 of FIG. 1 (either with host physical addresses (HPA) or host virtual addresses (HVA)), or FAM 116 address space. The completion SM 220 may be responsible for consuming response packets and translating the response packets to appropriate completion structures.

The control and status registers (CSR) banks 202 may include submission and completion queue pointers. The command fetch SM 204 may be a hardware-based state machine that may monitor submission queue pointers in the CSR registers 202 (i.e., Register Interface). The command fetch SM 204 may fetch a request 242 placed in the CSR registers 202 and may push the request 242 to the appropriate one of the sub-command queues 206. For example, and without limitation, the sub-command queues 206 may be queues that hold requests and include a message request queue 206(1), an atomic operation request queue 206(2), and a data transfer (e.g., DMA) request queue 206(3).

The optional Address Translation Services (ATS) cache 226 may be used, based on the application, to improve performance. The ATS cache 226 may hold virtual address to physical address translations. The ATS SM 224 is an address translation services state machine that may be used to fetch a virtual address to physical address translation, such as from a host system Input/Output memory management unit (IOMMU). The ATS request interface 222 may be used to interface to a host system address translation service and may be configured based on the system and operation system (OS) with which the ATS request interface 222 is interacting.

The message issue SM 208 is a state machine that may be armed by a request (e.g., the request 242) in the associated message request queue 206(1) and may issue a write message command to a component in the memory fabric. The atomic issue SM 212 is a state machine that may be armed by a request in the associated atomic command queue 206(2) and may issue an atomic command to a computational device in the memory fabric. As used herein, the term atomic command refers to an instruction (e.g., add, subtract, logical AND, logical OR, and the like) for a computation device on the fabric to execute that is guaranteed access and update of a shared single word variable. The read data SM 216 is a state machine that may be armed by a request in the associated read direct memory access (DMA) command queue 206(3) and may issue a read command to a device on the memory fabric, or to host memory. The write data SM 218 is a state machine that may be armed by a request in the associated write DMA command queue 206(3) and may issue a write command to a device on the memory fabric or to host memory.

The read master (host side) 228 may interface to an appropriate host that issues read requests to satisfy read DMA commands. The read master (fabric side) 230 may interface an appropriate fabric memory and may issue read requests to satisfy read DMA commands. The write master (fabric side) 232 may interface to a fabric and may issue write requests to satisfy a write DMA, a write message, and atomic commands. The write master (host side) 234 may interface to an appropriate host that issues write requests to satisfy write DMA commands.

In a method aspect of the present invention, for example, and without limitation, the message completion block 210 accepts completions after a write message command has been completed, posts completion information to the completion queue, and updates the completion queue pointers in the register interface 202. The atomic completion block 214 accepts completions after an atomic command has been completed, posts completion information to the completion queue, and updates the completion queue pointers in the register interface 202. The DMA completion block 220 accepts completions when a DMA command has been completed, posts completion information to the completion queue, and updates the completion queue pointers in the register interface.

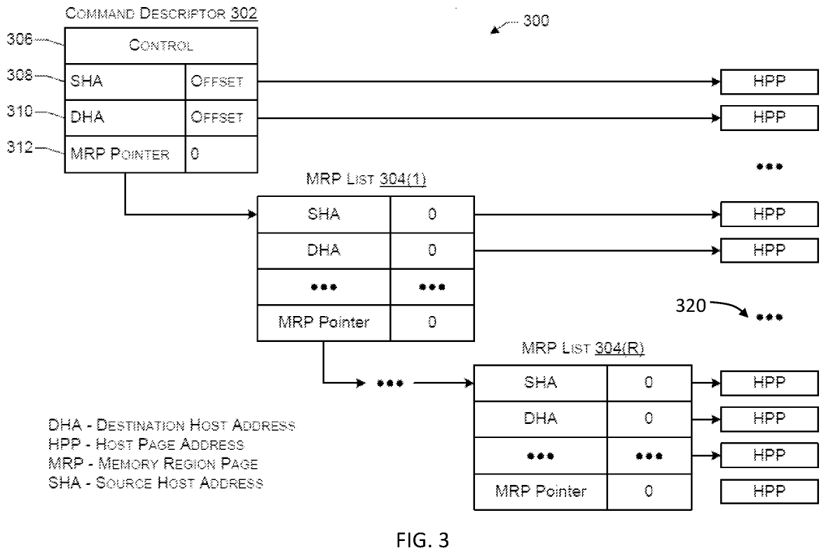

The linked list diagram 300 (also referred to herein as a Memory Region Page (MRP)) of FIG. 3 illustrates an exemplary command descriptor and associated memory region page (MRP) lists that may be used to initiate supported operations in a ZDMA engine 124 of FIGS. 1 and 2, according to certain embodiments of the present invention. As illustrated in the example of FIG. 3, linked list diagram 300 includes a command descriptor table 302 and multiple MRP lists 304(1) to 304(R), where R is greater than 0.

The ZDMA engine 124 of FIG. 1 and FIG. 2 may receive input using a command descriptor, such as the command descriptor 302. For example, and without limitation, the driver 134 of FIG. 1 may place the command descriptor 302 in the register interface (CSR 202 of FIG. 2) to cause the ZDMA engine 124 to perform the command described in the command descriptor 302. The request 242 may include the command descriptor 302.

The operations performed by the ZDMA engine 124 may be initiated by software (e.g., OS 130 or driver 134) building the command descriptor 302 and using command queues 206 (as shown in FIG. 2) to send the ZDMA engine 124 a pointer to the command descriptor 302 for processing. The ZDMA engine 124 may retrieve the command descriptor 302 and may execute the associated command as described hereinbelow (i.e., in response to command descriptors either for non-data commands (atomic commands) or for data type commands).

Commands that transfer data (e.g., write message, read data, write data) may require that data be sent from, or received to, non-contiguous memory locations. To enable transferring data to or from disparate locations, the ZMDA engine 124 may be programmed with the Memory Region Page (MRP) 300 that includes a list to describe the source and destination transfer locations (e.g., source address/offset/length and destination address/offset/length). As illustrated in FIG. 3, the MRP 300 includes the command descriptor 302. Atomic commands do not transfer data. Therefore, the structure of the command is included in the command descriptor 302 and does not use memory region page (MRP) lists.

The command descriptor table 302 may include a control field 306, a source host address (SHA) 308, a destination host address (DHA) 310, and MRP pointer 312 that may include a pointer to the first table in the MRP list 304 (e.g., 304(1)). Each MPRP list 304(1) to 304(R) may include multiple SHAs, multiple DHAs, and an MRP pointer to a next MRP list 304. For example, and without limitation, the MRP pointer in MRP list 304(1) may point to MRP list 304(2), the MRP pointer in MRP list 304(2) may point to MRP list 304(3), and so on. Each of the SHA and the DHA may point to a host page address (HPP) 320, as illustrated in FIG. 3.

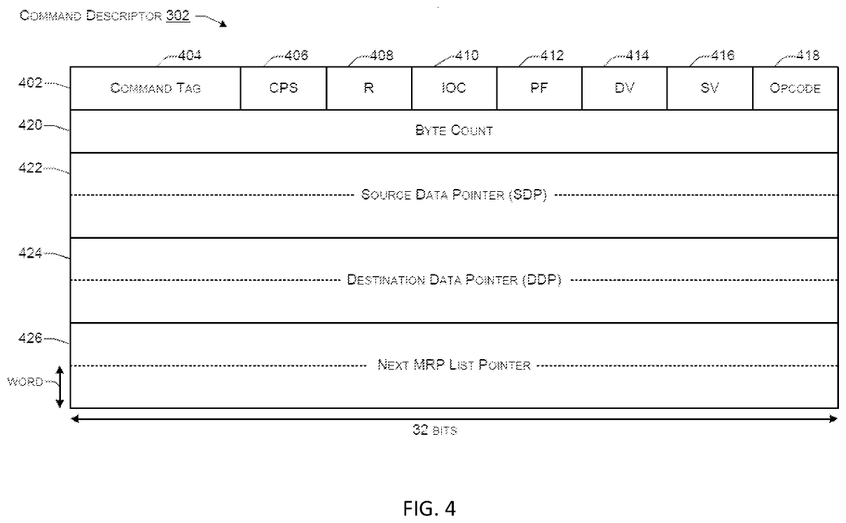

FIG. 4 illustrates an exemplary MRP command descriptor (e.g., the command descriptor 302 of FIG. 3), according to certain embodiments of the present invention. The command descriptor 302 may include multiple words. In the illustrated example, each word has 32 bits. However, in various embodiments of the present invention, words having a size that is greater or smaller than 32 bits may be used. A first word 402 may include a command tag 404, a command page size (CPS) 406, one or more reserved (R) bits 408, Interrupt On Completion (IOC) 410, pre-fetch (PF) 412, destination virtual (DV) 414, source virtual (SV), and/or opcode 418.

A second word of the command descriptor 302 may include a byte count 420 associated with the command descriptor 302. The third and fourth words of the command descriptor 302 may include a source data pointer 422. The fifth and sixth words of the command descriptor 302 may include the destination data pointer 424. The seventh and eighth words of the command descriptor 302 may include an MRP list pointer 426 to the MRP list (e.g., the MRP list 304(1) to 304(R) of FIG. 3).

The opcode 418 field of the command descriptor 302 may indicate the opcode type (e.g., whether the opcode is ZDMA command data, an atomic, or a message). The source virtual (SV) 416 field may be a Boolean that indicates whether the source address is a virtual address or not a virtual address. The destination virtual (DV) 414 field may be a Boolean that indicates whether or not the destination address is a virtual address. The pre-flush (PF) 412 field may be a Boolean that, when set, causes all commands preceding this command to be completed. The interrupt on completion (IOC) 410 field may be a Boolean that, when set, instructs the controller to generate an interrupt (e.g., MSI-X interrupt) after the controller acknowledges completion of the last data movement associated with the command. The command page size (CPS) 406 may indicate the size of pages used for data and for MRP lists associated with the command. The CPS 406 may have a valid range between zero (0) and twenty (20), with other values being reserved for future use. The page size may be described as a power of two: page size=2\hat{ }(CPS+12)

The byte count 420 may indicate the total number of bytes being moved by this command. The source data pointer (SDP) 422 may indicate the starting address of the data source associated with the command. The SDP 422 in the command descriptor 302 may have a non-zero offset into the page, with a maximum value of (2\hat{ }(CPS+12))−1.

The destination data pointer (DDP) 424 may indicate the starting address of the data destination associated with the command. The DDP 424 in the command descriptor 302 may have a nonzero offset into the page, with a maximum value of (2\hat{ }(CPS+12))−1.

As illustrated in FIG. 4, the SDP 422, DDP 424, and the next MRP list pointer 426 may each be up to two words (e.g., 2×32 bits=64 bits).

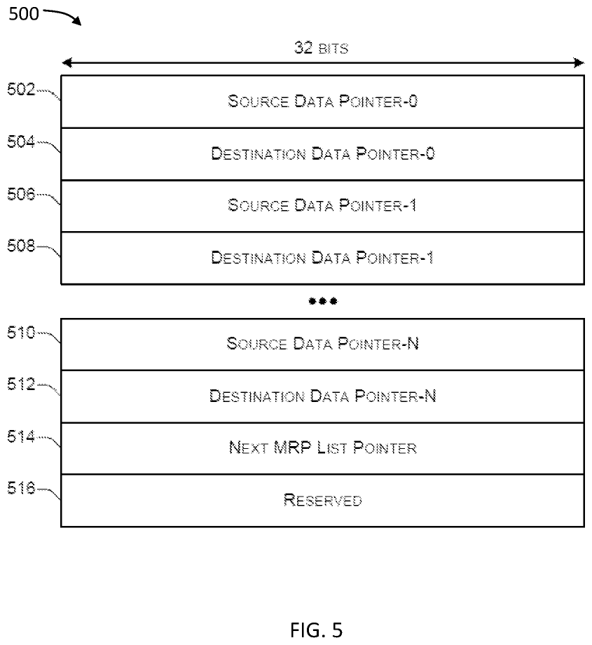

FIG. 5 illustrates an exemplary MRP list 500 (e.g., one of the MRP lists 304 of FIG. 3), according to certain embodiments of the present invention. Each MRP list 500 may include a source data pointer (indicating from where data is to be moved) and a corresponding destination data pointer (indicating to where data is to be moved), such as an SDP-0 502, a DDP-0 504, an SDP-1 506, a DDP-1 508, up to an SDP-N 510 where N is greater than 1, and a corresponding DDP-N 512. In the illustrated example, the SDP and DDP are numbered from 0 to N. The MRP list 500 may include a pointer 514 to a next MRP list (see also MRP pointer 312 in FIG. 3).

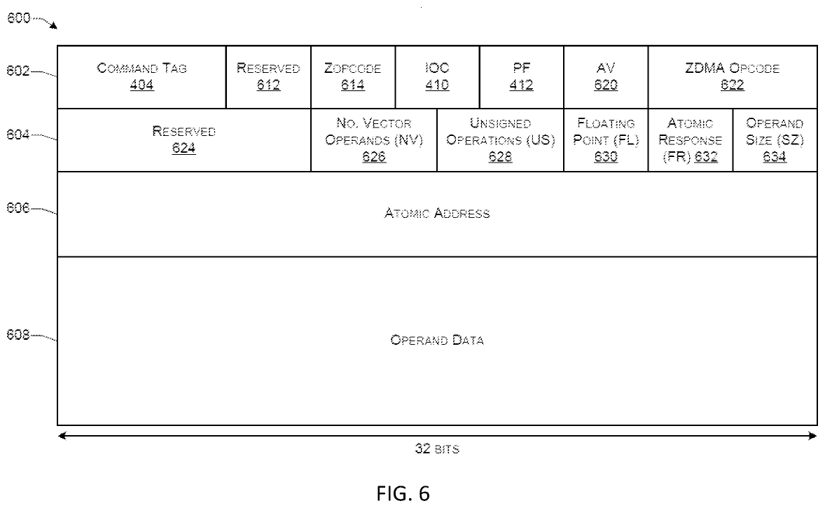

FIG. 6 illustrates an exemplary command descriptor 600 (e.g., the command descriptor 302 of FIG. 3) for an atomic operation, according to certain embodiments of the present invention. The command descriptor 600 may include multiple 32-bit words (as shown in the present example, including one or more words 602, 604,606, 608).

The word 602 may include the command tag 404 that indicates whether the command is for an atomic operation. One or more bits 612 of the word 602 may be reserved for future use. The word 602 may include a Zopcode 614, the IOC 410, the PF 412, address virtual (AV) 620, and ZDMA opcode 622. The ZDMA opcode 622 may include a single address atomic operation (op). The address virtual (AV) 620 may be a Boolean indicating whether the source address is a virtual address. ZDMA commands may be one of 3 types: (1) data commands, (2) atomic commands, and (3) message commands. The data commands may be (i) Host Memory to Fabric, (ii) Fabric to Host Memory, and/or (iii) Fabric to Fabric. The atomic commands may be 128-bit atomic operations that include a flush/barrier bit. If the flush/barrier bit is set in an atomic command, then all commands that precede the atomic command in a submission queue in which the atomic command was placed will complete prior to initiation of the atomic operation. The message command may include reliable/unreliable control, a request and response context (CTX) identifier (ID), and an instance ID.

The pre-flush (PF) 412 field may be a Boolean indicating whether all commands preceding this command are to be completed prior to execution of this command. The interrupt on completion (IOC) 410 may be a Boolean that, when set, causes the controller to generate an interrupt (e.g., am MSI-X interrupt) after the controller acknowledges completion of the last data movement associated with the command. The Zopcode 614 may indicate the atomic-1 opclass opcode used for this command.

The word 604 may include one or more reserved bits 624, a number of vector operands (NV) 626 (e.g., NV=2\hat{ }(SZ+3)), an unsigned (US) 628 Boolean indicating whether operations are unsigned (e.g., 0=signed, 1=unsigned), a floating point (FL) 630 Boolean indicating whether the data and operands use floating point (e.g., 0 indicates integer data and integer operands, 1 indicates floating point data and floating-point operands), an atomic response (FR) 632 (e.g., set to 1′b1 to indicate atomic response data is to be returned), and/or an operand size (SZ) 634 (e.g., 2\hat{ }(SZ+3) indicates the size of the operand).

The one or more words 606 (e.g., two words as illustrated in FIG. 6) may include an atomic address that may be aligned to the operand size. The one or more words 608 (e.g., four words as illustrated in FIG. 6) of the command descriptor may include operand data that is packed starting at byte 0 of 608.

For atomic operations, the supported operand size may include 8 bit (b), 16b, 32b, 64b, 128b, and 256b. Atomic response data (data provided in response to an atomic) may be placed into a completion structure (eliminating a software double read). The atomics may support Big-Endian (BE) Atomics. A particular atomic request may use a same size for the operand, the accessed memory, and/or the returned data. For example, and without limitation, a 32-bit ADD uses a 32-bit ADD operand, operates on a 32-bit memory location, and returns a 32-bit summed result. Opcodes that may be supported: Add, Sum, Swap, Compare and Swap (CAS), CAS Not Equal, Logical OR, Logical XOR, Logical AND, Load Max, Load Min, Test Zero and Modify, Increment Bounded, Increment Equal, Decrement Bounded, Compare Store Twin, Atomic Vector Sum, Atomic Vector Logical, and Atomic Fetch.

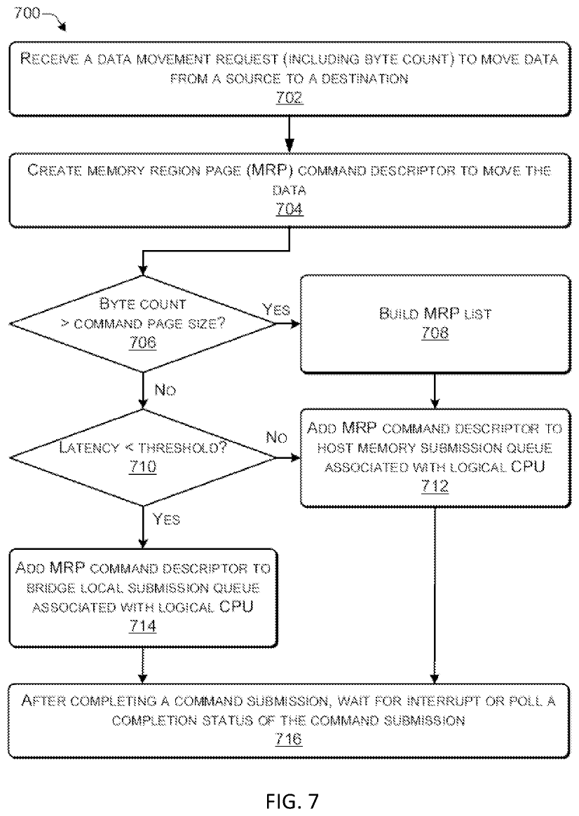

In the flow diagrams of FIGS. 7, 8, and 9, each block represents one or more operations that may be implemented in hardware, software, or a combination thereof. In the context of software, the blocks represent computer-executable instructions that, when executed by one or more processors, may cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations may be combined in any order and/or in parallel to implement the processes. For discussion purposes, the processes 700, 800, and 900 are described with reference to FIGS. 1, 2, 3, 4, 5, and 6 as described above, although other models, frameworks, systems and environments may be used to implement these processes.

FIG. 7 is a flowchart of a process 700 that includes a data movement request, according to certain embodiments of the present invention. The process 700 may be performed by the ZDMA engine 124 of FIG. 1 and FIG. 2.

At Block 702, the process may receive a data movement request to move data from a source to a destination (the data movement request includes a byte count indicating how many bytes of data are requested to be moved).

At Block 704, the process may create a memory region page (MRP) command descriptor to move the data.

At Block 706, the process may determine whether the byte count is greater than a command page size (CPS). If the process determines, at Block 706, that “yes” the byte count is greater than the command page size, then the process builds an MRP list, at Block 708, and proceeds to Block 712. If the process determines, at Block 706, that “no” the byte count is not greater than (e.g., is less than or equal to) the command page size, then the process proceeds to Block 710.

At Block 710, the process may determine whether a latency is less than a threshold (e.g., determine whether there is low latency). If the process determines, at Block 710, that “no” the latency is not less than the threshold, then the process may proceed to Block 712. At Block 712, the process may add an MRP command descriptor to a host memory submission queue associated with the logical CPU, and the proceeds to Block 716. If the process determines, at Block 710, that “yes” the latency is less than the threshold, then the process may proceed to Block 714 where the MRP command descriptor is added to a bridge local submission queue associated with a logical CPU, and then proceeds to Block 716.

At Block 716, after the process determines that the command submission is complete, the process may wait for an interrupt or poll completion status (e.g., poll the status of the command submission to determine whether the command has been completed).

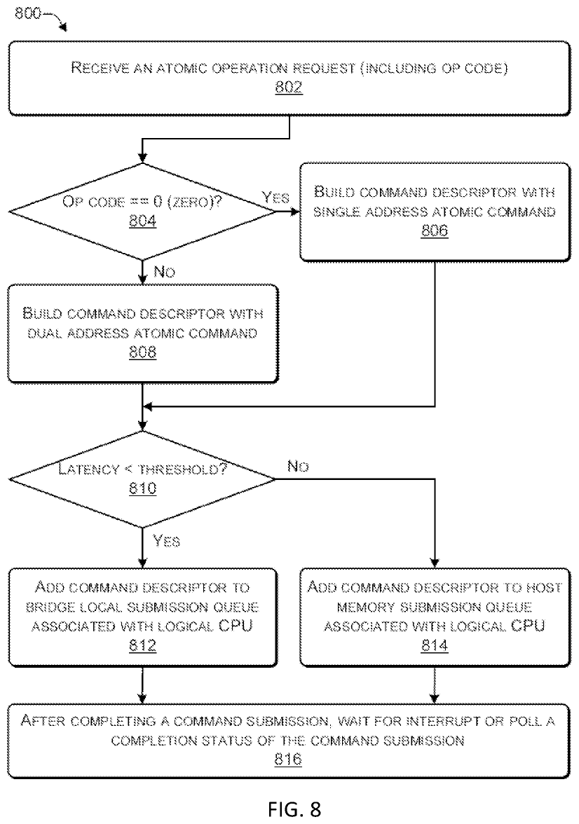

FIG. 8 is a flowchart of a process 800 that includes receiving a request to perform an atomic operation, according to certain embodiments of the present invention. The process 800 may be performed by the ZDMA engine 124 of FIG. 1 and FIG. 2.

At Block 802, the process may receive an atomic operation request that includes an opcode (e.g., as shown in FIG. 6). At Block 804, the process may determine whether the opcode is equal to zero. If the process determines, at Block 804, that “yes” the opcode is equal to zero, then the process proceeds to Block 806, where the process may build a command descriptor with a single address atomic command, and then proceeds to Block 810. If the process determines, at Block 804, that “no” the opcode is not equal to zero, then the process proceeds to Block 808 where the process may build a command descriptor with a dual address atomic command, and then proceeds to Block 810.

At Block 810, the process may determine whether latency is less than a threshold amount (e.g., whether there is low latency). If the process determines, at Block 810, that “yes” the latency is less than the threshold (e.g., there is low latency), then the process proceeds to Block 812, where the process may add the command descriptor to a bridge local submission queue associated with a logical CPU, and then proceeds to Block 816. If the process determines, at Block 810, that “no” the latency is not less than the threshold, then the process proceeds to Block 814, where the process may add the command descriptor to a host memory submission queue associated with a logical CPU, and then proceeds to Block 816. At Block 816, after completing the command submission, the process may wait for an interrupt or polls a completion status of the command submission.

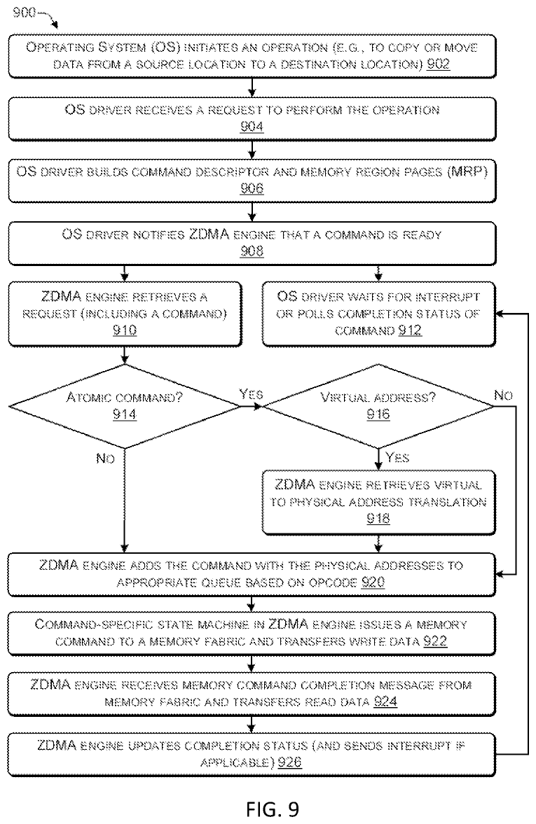

FIG. 9 is a flowchart of a process 900 that includes a ZDMA engine retrieving a command, according to certain embodiments of the present invention. In the process 900, the operating system 130 may perform Blocks 902, 904, 906, 908, 912 and the ZDMA engine 124 of FIG. 1 and FIG. 2 may perform Blocks 910, 914, 916, 918, 920, 922, 924, and 926.

At Block 902, the operating system may initiate an operation. At Block 904, the OS driver may receive a request to perform the operation. For example, in FIG. 1, the operating system 130 may initiate an operation and the driver 134 may receive a request to perform the operation.

At Block 906, the OS driver may build a command descriptor and memory region pages (MRP). For example, the driver 134 of FIG. 1 may create the command descriptor 302 of FIG. 3 that includes the memory region pointer (MRP) 312 to the memory region list 304.

At Block 908, the OS driver may notify the ZDMA engine that a command is ready for execution. At Block 910, the ZDMA engine may retrieve the command (e.g., from the register interface). At Block 912, after determining that the ZDMA engine has retrieved the command, the OS driver either (i) waits for an interrupt to indicate that the command has been executed (e.g., completed) or (ii) polls a completion status of the command. For example, in FIG. 2, the driver 134 of FIG. 1 may create the command descriptor 302 of FIG. 3 and place the command descriptor 302 in the CSR 202 (e.g., as the request 242) to indicate that a command is ready for execution. In response to determining that the request 242 has been placed in the CSR 202 (register interface), the ZDMA engine 124 may retrieve the command (e.g., the request 224) from the CSR 202. After determining that the ZDMA engine 124 has retrieved the command (e.g., the request 242), the driver 134 may either wait for an interrupt to indicate that the command has been completed or periodically, at a predetermined interval, may poll to determine whether the command has been completed.

At Block 914, after the ZDMA engine retrieves the command, the process may determine whether the command is an atomic command. If the process determines, at Block 914, that “yes” the command is an atomic command, then the process proceeds to Block 916. If the process determines, at Block 914, that “no” the command is not an atomic command, then the process proceeds to Block 920. For example, in FIG. 2, after retrieving the command (e.g., request 242) from the CSR 202, the ZDMA engine 124 may determine whether the command (e.g., in the command descriptor 302) is an atomic command.

At Block 916, the process may determine whether the command includes a virtual address. If the process determines, at Block 916, that the command does not include a virtual address, then the process may proceed to Block 920. If the process determines, at Block 916, that the command includes a virtual address, then the ZDMA engine may retrieve a virtual address to physical address translation, at Block 918. For example, if the ZDMA engine 124 determines that the command (e.g., the request 242) includes a virtual address, then the ZDMA engine 124 may use the address translation services (ATS) request interface 222 to translate the virtual address to a physical address.

At Block 920, the ZDMA engine may add the command with the physical addresses to an appropriate queue, based on an opcode included in the command. For example, in FIG. 2, the ZDMA engine 124, based on the opcode 418 included in the command descriptor 302, may place the command, along with the physical addresses received from the ATS request interface 222, into one of the queues 206.

At Block 922, a command specific state machine in the ZDMA engine may issue a command to a memory fabric and transfers write data. For example, in FIG. 2, an appropriate one of the state machines 208, 212, 216 issues a command to a memory fabric (e.g., using one of 230, 234) and transfers write data.

At Block 924, the ZDMA engine may receive a command completion message from the memory fabric and may transfer read data. At Block 926, the ZDMA engine may update a completion status (e.g., indicating whether the command has been completed) associated with the command and, if applicable, may send an interrupt to indicate that the command has been completed and then proceeds to Block 912. For example, in FIG. 2, a status of the message completion 210, the atomic completion 214, or the DMA completion 220 may be updated by one of 228, 230, 232, 234. If configured to do so, the ZDMA engine 124 may provide an interrupt to indicate that the command has been completed.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus, the scope of the invention should be determined by the appended claims and their legal equivalents, and not by the examples given.

That which is claimed is:

1. A computer-implemented method of performing memory access operations, comprising:
receiving, using a register interface of a memory access engine, a request comprising a command including an address value and an opcode;
determining, upon detection of the opcode of atomic command type by the memory access engine, an address type for the address value;
translating, using an address translation service and upon detection of the address type of virtual address type by the memory access engine, the address value to a physical address for the command;
setting, upon detection of the address type of physical address type by the memory access engine, the physical address for the command to the address value;
adding, by the memory access engine, the command and the physical address to at least one queue configured in data communication with a memory fabric based on the opcode;
operating, by the memory access engine, the memory fabric based on the command while a central processing unit (CPU) is performing processing tasks; and
receiving a message from the memory fabric indicating completion of the command.

2. The computer-implemented method according to claim 1, further comprising transmitting, using an operating system driver, the request to the register interface.

3. The computer-implemented method according to claim 1, wherein the at least one queue further comprises one of:
a message request queue,
an atomic operation request queue, and
a data transfer request queue.

4. The computer-implemented method according to claim 1, wherein the opcode further comprises one of:
command data,
a command type, and
a message.

5. The computer-implemented method according to claim 1, wherein the command further comprises:
a source data pointer; and
a destination data pointer.

6. The computer-implemented method according to claim 1, wherein the command further comprises:
a command descriptor; and
a plurality of memory region pages.

7. The computer-implemented method according to claim 1, wherein the address translation service further comprises an address translation services state machine.

8. A memory access engine configured to perform operations comprising:
receiving, using a register interface, a request comprising a command including an address value and an opcode;
determining, upon detection of the opcode of atomic command type, an address type for the address value;
translating, using an address translation service and upon detection of the address type of virtual address type, the address value to a physical address for the command;
setting, upon detection of the address type of physical address type, the physical address for the command to the address value;
adding the command and the physical address to at least one queue configured in data communication with a memory fabric based on the opcode;
operating the memory fabric based on the command while a central processing unit (CPU) is performing processing tasks; and
receiving a message from the memory fabric indicating completion of the command.

9. The memory access engine according to claim 8, further comprising updating, upon receiving the message from the memory fabric, a status associated with the command to a completed status.

10. The memory access engine according to claim 8, wherein the at least one queue further comprises:
a message request queue,
an atomic operation request queue, or
a data transfer request queue.

11. The memory access engine according to claim 8, wherein the opcode further comprises:
command data,
a command type, or
a message.

12. The memory access engine according to claim 8, wherein the command further comprises:
a source data pointer; and
a destination data pointer.

13. The memory access engine according to claim 8, wherein the command further comprises:
a command descriptor; and
a plurality of memory region pages.

14. The memory access engine according to claim 8, wherein the address translation service further comprises an address translation services state machine.

15. A system comprising:
a plurality of processing units, individual processing units of the plurality of processing units executing an operating system; and
a memory access engine configured to perform operations comprising:
receiving from one of the plurality of processing units a request comprising a command including an address value and an opcode;
determining, upon detection of the opcode of atomic command type, an address type for the address value;
translating, upon detection of the address type of virtual address type, the address value to a physical address for the command;
setting, upon detection of the address type of physical address type, the physical address for the command to the address value;
operating, based on the command and the physical address, a memory fabric while a central processing unit (CPU) is performing processing tasks; and
receiving a message from the memory fabric indicating completion of the command.

16. The system according to claim 15, wherein an operating system driver of the operating system creates the request.

17. The system according to claim 15, wherein the plurality of queues further comprises:
a message request queue,
an atomic operation request queue, or
a data transfer request queue.

18. The system according to claim 15, wherein the opcode further comprises on of:
command data,
a command type, or
a message.

19. The system according to claim 15, wherein the command further comprises:
a command descriptor, and
a plurality of memory region pages.

20. The system according to claim 15, wherein the address translation service further comprises an address translation services state machine.
